(19) United States
(12) Patent Application Publication
(10) Pub. No.: US 2008/0159514 A1
(43) Pub. Date: Jul. 3, 2008

(54) TELECOMMUNICATION DEVICE

(75) Inventors: W. Garland Phillips, Barrington, IL (US); Thomas J. Mactavish, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/617,921

(22) Filed: Dec. 29, 2006

(51) Int. Cl. H04M 3/42

(52) U.S. Cl. 379/215.01

(57) ABSTRACT

An electronic device and a method are for responding to an incoming call. The response is performed by receiving the incoming call, analyzing features within the incoming call to determine a stress level, presenting an intervention alert when the stress level meets a defined criterion, and holding the incoming call to allow a user to answer the incoming call. In some embodiments, presence of a suppressed mode is determined prior to receiving the incoming call and the steps of analyzing features and holding the incoming call are performed only when suppressed mode is determined to be present.

### FIELD OF THE INVENTION

The present invention relates generally to a telecommunication device and more particularly to responding to an incoming call made to a telecommunication device.

### BACKGROUND

It is well known that the telecommunication devices such as cellular phones, have modes in which the level of sounds is suppressed. For example, in a meeting mode, the cellular phones are either on a silent mode or on a vibration mode, so that the meeting does not get disturbed. In this meeting mode, audio alerts are generally not passed to a user even in situations where the user should be alerted of highly urgent calls. The problem in many instances is that either the control functions provided in the system do not indicate an urgent nature of an associated call, or in some systems they do indicate an urgent nature of an associated call, but the receiving device cannot use the function.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram of a system in accordance with some embodiments;

FIG. 2 is a block diagram of the apparatus used in some embodiments; and

FIG. 3 is a flowchart of some steps of a method in accordance with some embodiments;

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in a user electronic device that functions in a telecommunication system. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Referring to FIG. 1, a diagram of a system 100 is shown in accordance with some embodiments. The system 100 comprises a caller's device 102, an electronic device 104, a network 106 and may comprise an external database 108. A caller may use the caller's device 102 to make a call to the electronic device 104, wherein the caller's device 102 can be a mobile phone, a landline phone, a walky-talky set or any other communication device. A user may use the electronic device 104, to receive an incoming call from the caller's device 102, wherein the electronic device 104 can be a mobile phone, a landline phone, a walky-talky set or any other communication device.

The network 106 supports the call connection between the caller's device 102 and the electronic device 104. The network for example, can be a GSM network, a CDMA network, a wired telephone line network, a WIMAX network, a voice over IP network, a 802.11 network and similar kind of networks.

The external database 108 is used to store a data, wherein the data is also referred as training history or previous data. The data is gathered by analyzing features of callers who have called the electronic device. There is separate data for each caller in the external database 108. The electronic device 104 may get the data downloaded into its memory from the external database 108 for a plurality of users or the electronic device 104 may ask for the data from the external database 108, whenever the electronic device 104 needs the data for a particular caller.

The electronic device 104 may operate in three or more modes that include, for example, a deep suppressed mode, a normal mode and a suppression mode. In the deep suppression mode, the electronic device 104 does not answer the incoming call. In deep suppression mode, the electronic device 104 is not off, but still the electronic device 104 will retain the missed calls and the messages received, without presenting any alert. For example, the deep suppression mode can be used when the user is in his/her wedding ceremony where the user just cannot endure any kind of interruption.

A difference between the suppressed mode and the normal mode is that in the suppressed mode, the urgency of the incoming call is detected by the electronic device 104, whereas in the normal mode the electronic device 104 does not detect urgency of the incoming call. For example, when the electronic device is in the suppressed mode, the urgency of the incoming call is detected and when the electronic device is in normal mode, the electronic device 104 responds to the incoming call without analyzing paralinguistic features within the incoming call.

In the suppressed mode, an intervention alert may be presented by the electronic device 104 to the user. The intervention alert can be, for example, a silent alert, a vibration alert, or a vibration cum loud alert may be used for noisy places. Other alerts and combinations could be used depending upon the environment. When the electronic device 104 is in a silent mode, only a light or message may blink (as an intervention alert) on the electronic device 104 at the reception of the incoming call. When the electronic device 104 is in a vibration mode, the electronic device 104 vibrates (as an intervention alert) at the reception of the incoming call. When the electronic device 104 is in vibration cum loud mode, the electronic device 104 vibrates as well gives out a loud sound (as an intervention alert) at the reception of the incoming call.

In normal mode, an alert is typically presented by the electronic device 104 upon the receipt of all incoming calls. The alert, for example, can be a silent alert, a vibration alert, a vibration cum loud alert may be used for noisy places and other alerts and combinations could be used depending upon the environment. When the electronic device 104 presents a silent alert, only a light blinks on the electronic device 104 at the reception of the incoming call. When the electronic device 104 presents a vibration alert, the electronic device 104 vibrates at the reception of the incoming call. When the electronic device 104 presents a vibration cum loud alert, the electronic device 104 vibrates as well gives out a loud sound at the reception of the incoming call.

Prior to receiving the incoming call, the electronic device 104 may need to be trained. Training may include analyzing features of at least one call of at least one caller and storing the features corresponding to the calls of each caller. The step of analyzing features comprises the analyses of at least one of the paralinguistic and linguistic features within the incoming call. Paralinguistic features refer to the non-verbal elements of audible communication used to modify meaning and convey emotion. Paralinguistic features may be expressed consciously or unconsciously and they include pitch, volume and intonation of speech. Linguistic features refer to the verbal elements of audible communication for which speech to text conversion has been performed or refer to received text words or messages.

The process of analyzing features may be done for all the callers calling a particular electronic device, and a separate set of data may be created and kept for each caller. The features are analyzed either by the electronic device 104 or by the network 106. Data sets of different callers may be assembled together at one place and the place may either be the external database 108 or an internal database in the electronic device 104. Training may also include populating the electronic device 104 with a data set of callers who have called the electronic device, within some limitation, such as a time limit or number of previous calls. In some embodiments, the data sets for callers who call a particular electronic device may be stored in the external database 108, and a data set of one of more callers may be retrieved from the external database 108 and stored in a memory of electronic device 104 during the training. Analyzing the features may include following an algorithm or using a neural network. Artificial intelligence or biometrics can also be used to analyze features.

When the electronic device 104 receives the incoming call, the features of the caller in this particular incoming call may get added to the data of the caller. Hence, the electronic device 104 may be a constant learner because it keeps on adding the features of the callers to the callers' respective data.

The training given to electronic device 104 can be either supervised or unsupervised. In supervised learning, the user determines whether a call was urgent or non-urgent, and provides such information to the electronic device, which uses the feedback for training. The user may determine the urgency of the call through communication with the caller or by other means. In un-supervised learning, the urgency of a call may be estimated by an algorithm or by using a neural network, without user feedback. Artificial intelligence or biometrics may also be used in un-supervised learning to estimate the urgency of the incoming call.

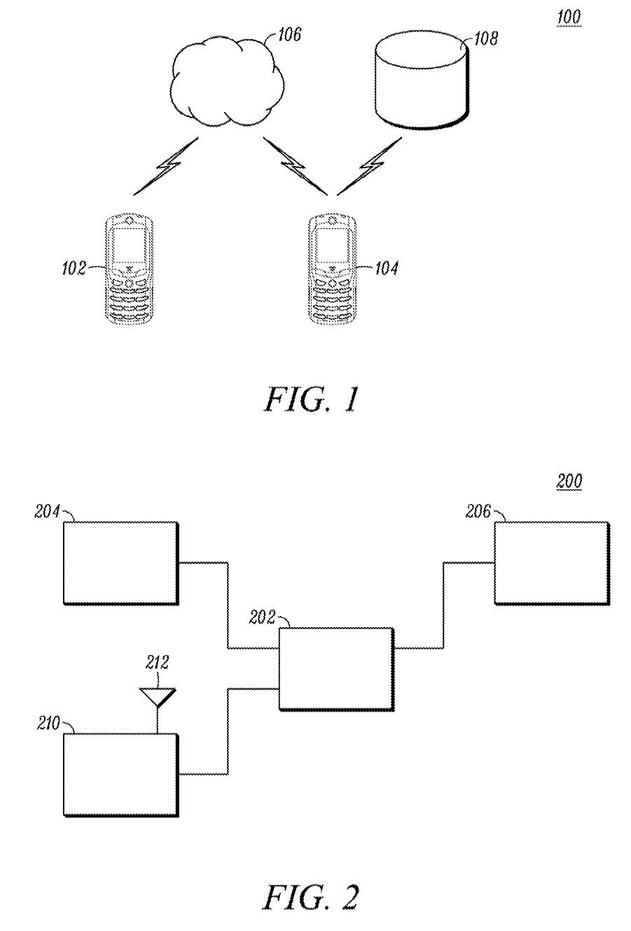

Referring to FIG. 2, a block diagram of the apparatus 200 used in some embodiments is shown. The apparatus comprises at least one output modality 206, a transceiver 210 with an antenna 212, at least one memory 204 and at least a processor 202. The transceiver 210 is used to receive the incoming call. The processor 202 analyzes features within the incoming call to determine a stress level. The output modality 206 is used for presenting the intervention alert when the stress level meets a defined criterion.

The processor 202 controls the transceiver 210 and the output modality 206 by executing programmed instructions, wherein the programmed instructions are stored in the at least one memory 204.

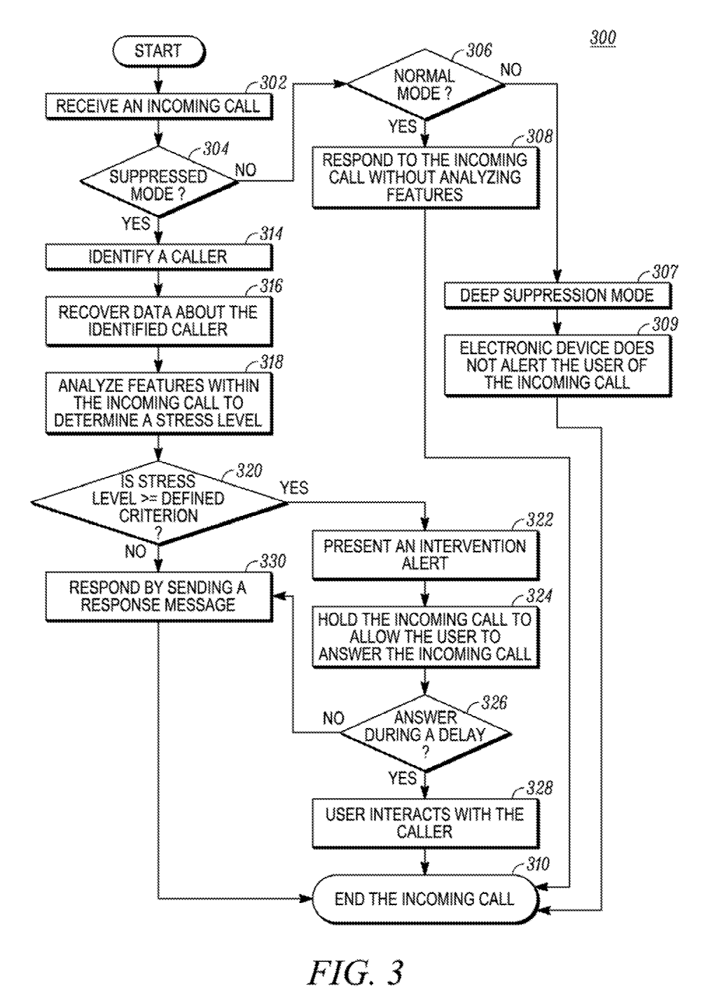

Referring to FIG. 3, a flowchart 300 shows some steps of a method in accordance with some embodiments. At step 302, an incoming call is received, wherein the incoming call has been originated by the caller. The caller uses the caller's device 102 to generate a phone number of the user's electronic device 104, wherein the user may not be aware that the call has been initiated. The above phenomenon is referred to as receiving the incoming call.

At step 304, the processor 202 checks for the presence of the suppressed mode. When the suppressed mode is determined to be absent, the electronic device 104 determines whether a normal mode has been selected, at step 306, and if the normal mode hasn't been selected, the electronic device determines that a deep suppression mode has been selected, at step 307. In the deep suppression mode, the electronic device does not alert the user about the incoming call. The electronic device may respond to the caller with a message indicating that the electronic device received the call, and other information, such as a message that may have been entered by the user, for example, that the user cannot be interrupted for any reason for a short while, but will respond as soon as possible thereafter. After this, the electronic device ends the call at step 310.

At step 306, the electronic device 104 operates in normal mode, wherein the user may answer the incoming call at step 308, and then end the incoming call at step 310. In another example, the electronic device may end the incoming call at step 310 when the user does not answer the incoming call.

At step 304, the processor 202 checks for the presence of the suppressed mode. When the suppressed mode is determined to be present, the electronic device 104 identifies the caller at step 314 by using, for example, a speech recognition system or caller identification information. At step 316, the electronic device 104 recovers data about the identified caller. The data is recovered either from the electronic device 104 or from the external database 108.

At step 318, the processor 202 analyzes features within the incoming call to determine the stress level. The stress level is based upon the recovered data in addition to the analyzed features. The step of analyzing features comprises the analysis of at least one of the paralinguistic and linguistic features within the incoming call. A paralinguistic stress level is determined based upon the paralinguistic features and a linguistic stress level is determined based upon the linguistic features. The (overall) stress level may be determined by both the paralinguistic stress level and the linguistic stress level and can therefore be said to be determined by analyses of at least one of the paralinguistic features and the linguistic features. The analysis of the linguistic features can be based on the learning of words that correspond to a particular stress level for a particular caller, and may include substantially different sets of words or phrases for different callers, as is well known in the art.

At step 320, the stress level may be compared with a defined criterion. The defined criterion is a preset value corresponding to a predefined stress level in the processor 202. The defined criterion and the stress level are used together to detect the urgency of the incoming call in certain embodiments by comparing the stress level with the defined criterion. For example, if the stress level is 5 units and the preset value of the defined criterion is 4 units, when the electronic device 104 compares the stress level and the defined criterion and determines that the stress level is greater than the defined criterion and hence the incoming call is determined to be urgent. When the stress level is determined to be less than 4, the incoming call is determined to be non-urgent.

At step 320, when the stress level is determined to be greater than or equal to the defined criterion, the stress level meets the defined criterion and the electronic device 104 judges the incoming call as urgent and an intervention alert is presented by the electronic device 104 at step 322. At step 324, the electronic device 104 may hold the incoming call to allow the user to answer the incoming call. (In some other embodiments, for example, the electronic device may answer the call automatically, in anticipation of the user wanting to talk immediately.) At step 326, it is determined whether the user answers the incoming call during a delay or not. When the user answers the incoming call, the user may interact with the caller at step 328 and then may end the incoming call at step 310. When the user does not answer the incoming call at this point, the user has basically overridden the stress detection. The electronic device 104 may learn from this and may respond to the incoming call by sending a first response message to the caller's device 102, at step 330. The first response message is either stored in the electronic device 104 or in the external database 108 and may be sent while holding the incoming call. The first response message can be a text or synthesized voice message like, “I am in a meeting, I will call you later” or “I am in a very noisy place, I will call you later”, or a similar kind of message. After the first response message is sent, the incoming call ends at step 310. The delay at step 326 is provided to allow the user time to answer the call, and may be, for example, about 15 seconds, during which the alert may be reactivated periodically. In some embodiments, an option may be provided at step 326 (not shown in FIG. 3) for the user to enter a command that causes the electronic device to respond with a text or synthesized message such as “I understand that your call may be urgent and I will respond very soon.”, and then end the call at step 310.

At step 320, when the stress level is determined not to meet the defined criterion, the electronic device 104 judges the incoming call as non-urgent. The electronic device 104 responds to the incoming call by sending a second response message to the caller's device 102, at step 330. The second response message is stored either in the electronic device 104 or in the external database 108. The second response message can be a message like, “I am in a meeting, I will call you later” or “I am in a very noisy place, I will call you later”, and similar kind of messages. After the second respond message is sent, the incoming call ends at step 310.

It will be appreciated that embodiments of the invention described herein may be comprised of one or more conventional processors and unique stored program instructions that control the one or more processors to implement, in conjunction with certain non-processor circuits, some, most, or all of the functions of the electronic device 104 described herein. The non-processor circuits may include, but are not limited to, a radio receiver, a radio transmitter, signal drivers, clock circuits, power source circuits, and user input devices. As such, these functions may be interpreted as steps of a method used in the electronic device 104 for responding to the incoming call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method used in an electronic device for responding to an incoming call comprising:
receiving the incoming call;
analyzing features within the incoming call to determine a stress level;
presenting an intervention alert when the stress level meets a defined criterion; and
holding the incoming call to allow a user to answer the incoming call.

2. The method of claim 1, further comprising determining the presence of a suppressed mode prior to receiving the incoming call and wherein the steps of analyzing features and holding the incoming call are performed only when suppressed mode is determined to be present.

3. The method of claim 1, further comprising determining the presence of a normal mode, wherein in the normal mode the electronic device responds to the incoming call without analyzing paralinguistic features within the incoming call.

4. The method of claim 1, further comprising determining the presence of a deep suppression mode, wherein in the deep suppression mode the electronic device does not answer the incoming call.

5. The method of claim 1, further comprising responding to the incoming call by sending a first response message, while holding the incoming call.

6. The method of claim 1, further comprising responding to the incoming call by sending a second response message, when the stress level does not meet the defined criterion, wherein the second response message is stored in the electronic device, and the second response message is sent after a delay.

7. The method of claim 1, further comprising:
identifying a caller of the incoming call; and
recovering data about the identified caller before analyzing features within the incoming call.

8. The method of claim 7, wherein the stress level is further based upon the recovered data in addition to the analyzed features.

9. The method of claim 1, wherein the steps of analyzing features further comprises at least one of the following:
analyzing paralinguistic features within the incoming call; and
analyzing linguistic features within the incoming call.

10. The method of claim 9, wherein the stress level is determined by the analyses of at least one of the paralinguistic features and the linguistic features.

11. The method of claim 1, further comprising training the electronic device prior to receiving the incoming call.

12. The method of claim 11, wherein training includes analyzing features of at least one call of at least one caller and storing the features corresponding to the calls of each caller.

13. An electronic device comprising:
at least one memory;
at least one output modality;
a transceiver; and
at least a processor, controlled by stored programmed instructions in the at least one memory to perform the functions of
receiving an incoming call using the transceiver,
analyzing features within the incoming call to determine a stress level,
presenting an intervention alert on the at least one output modality when the stress level meets a defined criterion, and
holding the incoming call to allow a user to answer the incoming call.

14. The electronic device of claim 13, further determines the presence of a suppressed mode prior to receiving the incoming call and wherein the steps of analyzing features and holding the incoming call are performed only when the suppressed mode is determined to be present.

15. The electronic device of claim 13, further determines the presence of a normal mode, wherein in the normal mode the electronic device responds to the incoming call without analyzing paralinguistic features within the incoming call.

16. The electronic device of claim 13, further determines the presence of a deep suppression mode, wherein in the deep suppression mode the electronic device does not answer the incoming call.

17. The electronic device of claim 13, further comprising responding to the incoming call by sending a first response message, while holding the incoming call.

18. The electronic device of claim 13, wherein the processor responds to the incoming call by sending a second response message, when the stress level does not meet the defined criterion, wherein the second response message is stored in the electronic device, and the second response message is sent after a delay.

19. The electronic device of claim 13, wherein the processor further
identifies a caller of the incoming call;
recovers data about the identified caller before analyzing features within the incoming call; and
determines the stress level, wherein the stress level is further based upon the recovered data in addition to the analyzed features.

20. The electronic device of claim 13, wherein the steps of analyzing features further comprises at least one of the following:
analyzing paralinguistic features within the incoming call;
analyzing linguistic features within the incoming call;
wherein the stress level is determined by the analyses of at least one of the paralinguistic features and the linguistic features.

21. The electronic device of claim 12, further comprising training the electronic device prior to receiving the incoming call, wherein training includes analyzing features of at least one call of at least one caller and storing the features corresponding to the calls of each caller.
